(19) United States
(12) Patent Application Publication
(10) Pub. No.: US 2003/0070316 A1
(43) Pub. Date: Apr. 17, 2003

(54) Wafer pedestal tilt mechanism and cooling system

(76) Inventors: Allan Weed, Marblehead, MA (US); Roger B. Fish, Bedford, MA (US)

Correspondence Address: CALFEE HALTER & GRISWOLD, LLP, 800 SUPERIOR AVENUE, SUITE 1400, CLEVELAND, OH, 44114, US

(21) Appl. No.: 09/975,360

(22) Filed: Oct. 11, 2001

(51) Int. Cl. F26B 25/00

(52) U.S. Cl. 34/107

(57) ABSTRACT

The invention provides a wafer pad assembly for use in an ion implanter for mounting and cooling a wafer. The wafer pad assembly comprises a wafer support pad having an upper surface for mounting the wafer and a lower surface. The lower surface of the wafer support pad is connected to a coolant passage having an inlet section and an outlet section arranged in an opposed configuration, wherein said inlet section is counterbalanced by said outlet section. The lower surface is connected to a frame having an outer curved surface in mating engagement with a complementary shaped bearing surface of a housing wherein said wafer can be tilted or rotated about an axis.

### FIELD OF THE INVENTION

The invention relates generally to ion implanters for the manufacture of semiconductor wafers, and more particularly to pedestals and wafer cooling systems for ion implanters.

### BACKGROUND OF THE INVENTION

Ion implanters are used to introduce conductivity-altering impurities into semiconductor wafers. In order to accomplish this, the desired impurity material is ionized via an ion source, and then accelerated to form an ion beam of prescribed energy. The ion beam is then directed at the surface of the semiconductor wafer so that the ions in the beam penetrate the semiconductor material and are embedded in the crystalline lattice thereby forming a region of desired conductivity.

In semiconductor wafer manufacturing, there are several important considerations in achieving an effective ion implanter. One important factor is throughput, or the number of wafers processed per time unit. In addition, wafer transfer time, ion implant time and down time are other important considerations. Another important factor is the ability to implant at high angle tilt. A high tilt angle, generally in the range of about 20 to about 60 degrees, allows doping of the silicon structure beneath an obstruction to the beam. Another important consideration is the ability to cool the wafers without resulting in a rotating unbalanced condition. This condition can occur when all of the pedestals do not move into position at the same time resulting in the coolant creating an unbalanced load. Thus, an ion implanter system capable of high wafer throughput, uniform dose with the capability of high tilt angle implantation and wafer cooling is desired.

### SUMMARY OF THE INVENTION

The invention provides in one aspect a wafer pad assembly for mounting and cooling a wafer and being disposed in an ion implanter. The wafer pad assembly comprises a wafer support pad having an upper surface for mounting the wafer and a lower surface. The lower surface of said wafer support pad is connected to a coolant passage having an inlet section and an outlet section arranged in an opposed configuration, wherein said inlet section is counterbalanced by said outlet section.

The invention provides in another aspect a wafer pad assembly for mounting a wafer and being disposed in an ion implanter. The wafer pad assembly comprises a wafer support pad having an upper surface for mounting the wafer and a lower surface that encloses the coolant passages. The lower surface is connected to a frame having an outer curved surface in mating engagement with a complementary shaped bearing surface of a housing wherein said wafer can be rotated about the axis of the centerline of the wafer mounted on the pad.

These and other aspects and advantages of the present invention will be readily understood and appreciated by those skilled in the art from the following detailed description of the preferred embodiments with the best mode contemplated for practicing the invention in view of the accompanying drawings.

### BRIEF DESCRIPTION OF THE FIGURES

FIG. 1 is a plan view of an ion implantation system;

FIG. 2 is a side view of a wafer pedestal assembly and cooling system of the present invention;

FIG. 3 is a top view of the wafer pedestal assembly shown in FIG. 2;

FIG. 4 is a front view of the wafer pedestal assembly and cooling system of the invention shown in FIG. 2;

FIG. 5 is a top view of the cooling passages of the wafer pedestal assembly shown in FIG. 4;

FIG. 6 is a side view of a wafer pedestal assembly and cooling system of the present invention shown in a tilted position; and

FIG. 7 is a perspective side view of the wafer pedestal assemblies mounted upon a disk of a batch type ion implanter.

### DETAILED DESCRIPTION OF THE INVENTION

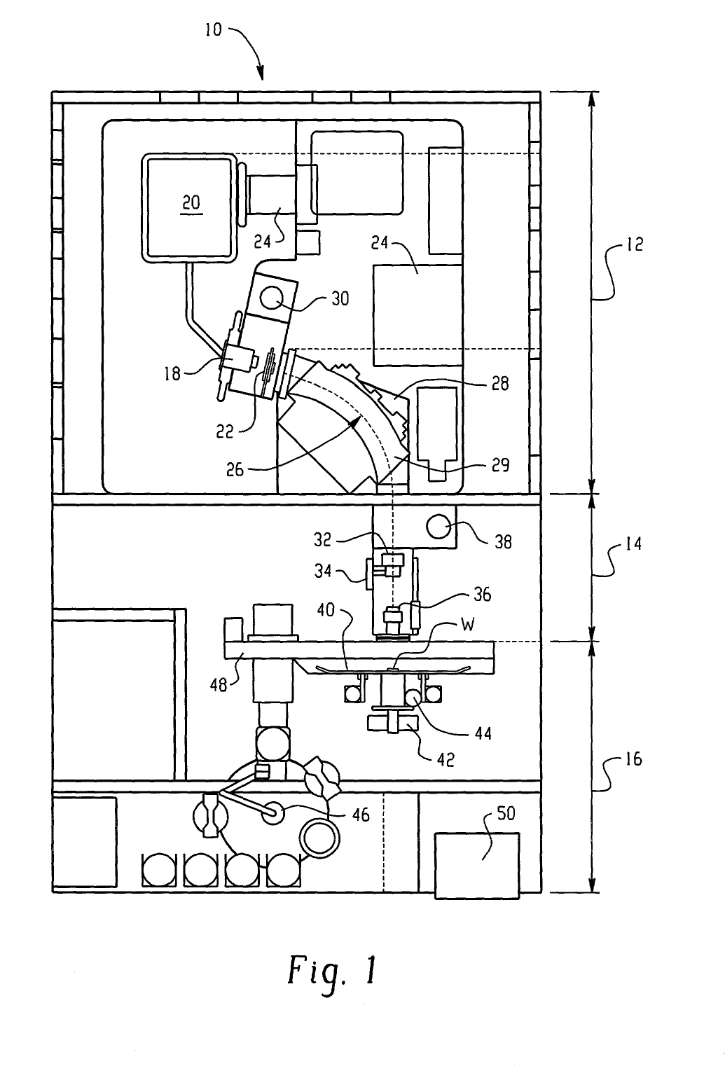

Referring now to the drawings, FIG. 1 discloses an ion implanter, generally designated at 10, which comprises a terminal 12, a beamline assembly 14, and an end station 16. Generally, the terminal 12 outputs an ion beam, and the beamline assembly 14 adjusts the focus, ion species and energy level of the ion beam and directs it toward a wafer W positioned at the end station 16.

The terminal 12 includes an ion source 18 having a chamber in which dopant gas from a gas box 20 is injected. Energy is imparted to the ionizable dopant gas to generate positive ions within the source chamber. An extraction electrode 22 powered by high voltage supply 24 extracts a beam 26 of positive ions from the source chamber and accelerates the extracted ions toward a mass analysis magnet 28. The mass analysis magnet 28 functions to pass only ions of an appropriate charge-to-mass ratio on to the beamline assembly 14. Evacuation of the beam path 29 provided by the mass analysis magnet 28 is provided by vacuum pump 30.

The beamline assembly 14 comprises a quadrature lens 32, a flag Faraday 34, an electron shower 36, and optionally an ion beam acceleration/deacceleration electrode (not shown). The quadrature lens 32 focuses the ion beam output by the terminal 12 and the flag Faraday 34 measures ion beam characteristics during system setup. The optional acceleration/deacceleration electrode may be used to accelerate or deaccelerate the focused ion beam to a desired energy level prior to implantation into a wafer at the end station 16. Evacuation of the beam path provided by the beamline assembly 14 is provided by vacuum pump 38.

The end station 16 includes a disk 40 upon which a plurality of wafers W are mounted. A rotary disk drive mechanism 42 is provided for imparting rotational motion to the disk, and a linear drive mechanism 44 is also provided for imparting linear motion to the disk. A robotic arm 46 loads wafers W onto the disk 40 via a load lock chamber 48. Operation of the system is controlled by an operator control station 50 located at the end of the end station 16.

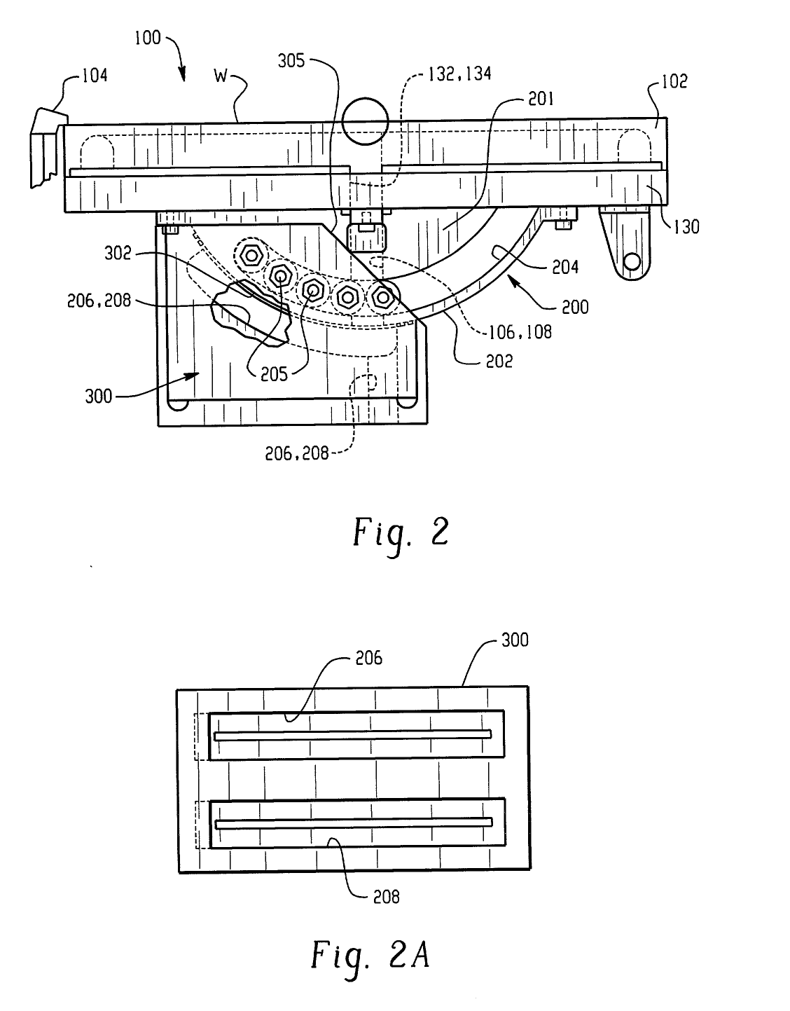

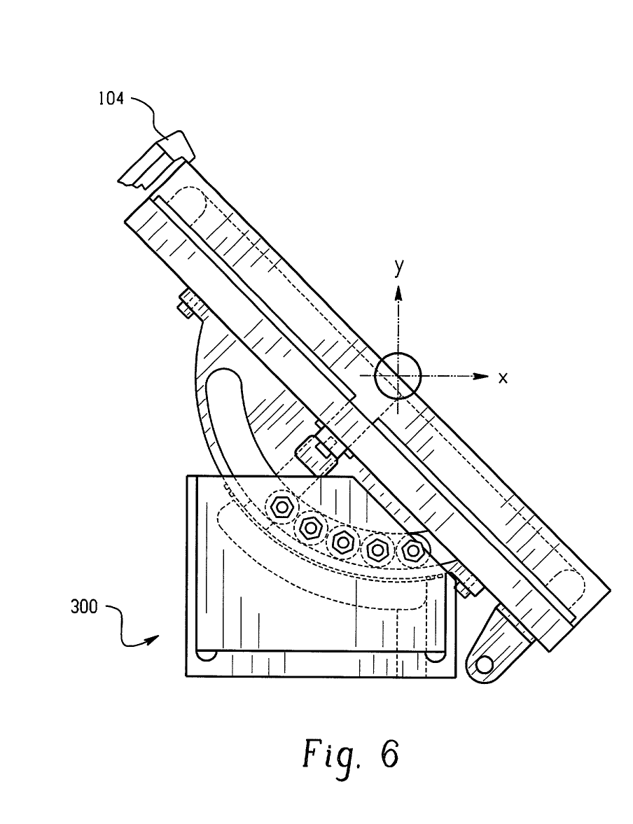

As shown in FIG. 2, each wafer W is mounted to the wafer pad assembly 100 of the present invention. The wafer pad assembly, shown generally at 100, provides for high angle tilting in the range of about zero to about 45 degrees of each individual wafer W. Tilting is defined as the rotation of the wafer W about the z axis, of the x, y, z coordinate system of the wafer pad assembly 100 as shown in FIG. 6. Preferably, the geometric centers of each wafer W is aligned with the Z axis so that each wafer is tilted about its geometric center.

Each wafer W is mounted upon and clamped to a wafer support pad 102 via one or more conventional clamps 104 such as a mechanical or electrostatic clamp or other means known to those skilled in the art. The wafer support pad 102 comprises a circular plate which has a substantially flat upper surface 104 for mounting a wafer W thereon. Mounted to the undersurface of the wafer support pad 102 is one or more cooling passages 103 (hereinafter referred to as “cooling passage”) for circulating coolant in order to cool the wafer. The cooling passage shall be dip brazed, bolted or held together by any conventional means. The cooling passage 103 preferably has a circular cross section and is comprised of a material having a high thermal conductivity such as aluminum. It is even more preferable that the interior surfaces of the cooling passages be coated with an anti-wear coating such as polytetrafluroethylene (PTFE) or any other form of hardcoat that prevents degradation of the pad base material.

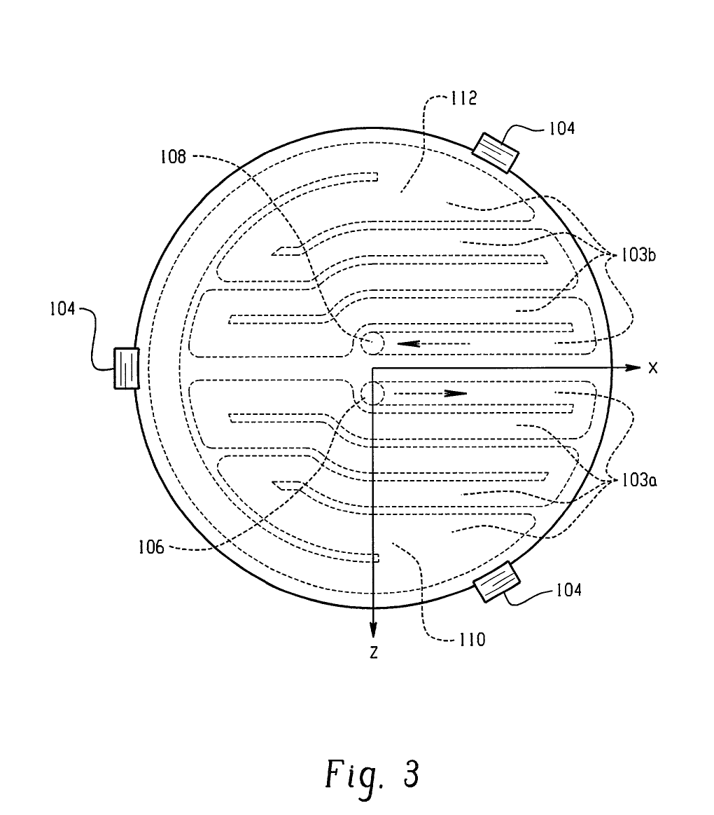

As shown in FIGS. 3 and 5, the cooling passage 103 has an inlet end 106 and a outlet end 108 located near the centerpoint of the wafer support pad 102. More specifically, the geometric centers of the inlet end 106 and the outlet end 108 are spaced in an opposed configuration equidistant from the geometric center of the wafer W. The coolant passage is arranged in a serpentine fashion that is symmetrical about an axis of the wafer support pad 102. As shown in FIG. 3 for illustrative purposes, the coolant passage is denoted as two sections “103a” and “103b”, wherein 103a is representative of the inlet section of the coolant passage, and 103b is representative of the outlet section of the coolant passage. As further shown in FIG. 3, section 103a and 103b are symmetrical about an axis, in particular, the x axis. This symmetrical relationship results in the coolant mass of the inlet section of the coolant passage 103a being counterbalanced by the coolant mass of the outlet section of the coolant passage, denoted as 103b. The end 110 of the inlet cooling passage 103a feeds into the inlet end 112 of the outlet cooling passage. The inlet coolant section 103a and the outlet coolant section 103b may also be arranged in numerous other configurations (not shown) such that the coolant mass of the inlet section is counterbalanced by the coolant mass of the outlet section.

The coolant provided in the inlet and outlet cooling passages may be any suitable cooling fluid such as water, antifreeze, freon or mixtures thereof, or any other suitable coolant known to those skilled in the art.

The lower surface of the wafer support pad 102 is secured to a FIXED cover plate 130. The cover plate 130 is also a flat circular plate and is made of Aluminum material, and functions to enclose the cooling passages and mount the assembly to the radius frame. The cover further comprises an inlet feed hole 132 and an outlet return hole 134 for receiving there through the ends 106, 108 of the respective inlet and outlet cooling fluid passages. As best shown in FIG. 2, the wafer pad assembly 100 further includes a wafer pad radius frame 200 which is mounted to the under surface of the cover plate 106. The radius frame 200 comprises an outer wear surface 202 having an exterior curved surface to allow rotation or “tilt motion” of the wafer pad assembly about the z axis which is also the geometric centerline of the top of the mounted wafer. The outer wear surface 202 has an outer convex surface and is aligned for slidable engagement with a complementary shaped bearing surface 302 of cam housing 300. As the outer wear surface 202 slidably engages the bearing surface 302, the wafer is preferably rotated about its geometrical center. The radius shape of the outer wear surface allows rotation of the wafer from 0 to 45 degrees. The outer wear surface 202 is formed of a material having a low coefficient of friction such as hard chrome or nickel plated steel or aluminum.

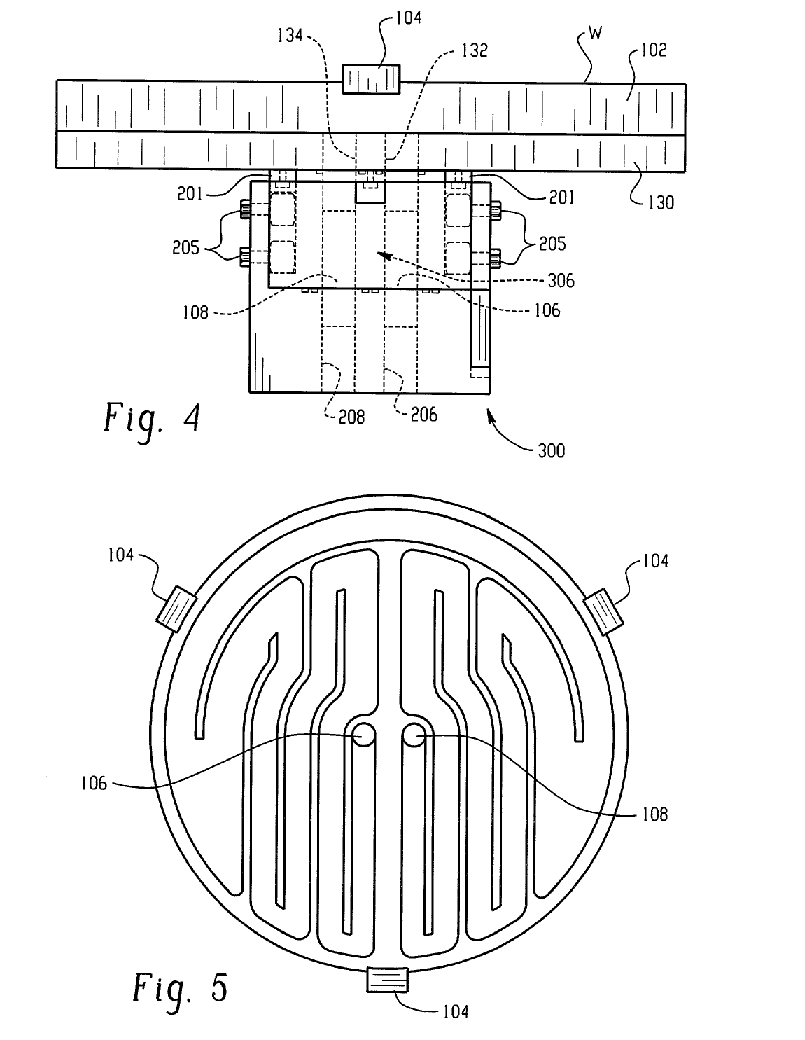

As shown in FIG. 4, the radius frame 200 has a rectangular cross section with opposed sidewalls 201. Mounted within the sidewalls 201 are one or more curved cam follower raceways 204. Preferably, two opposed raceways 204 are utilized. The cam follower raceways 204 have the same curvature as the outer wear surface 202. Received within each of the raceways 204 are one or more cam followers 205, which function to secure the semi-hemispherical frame 200 to the cam housing 300 while allowing the outer wear surface of the frame 200 to slidably engage the cam bearing surface so that the wafer can tilt. The cam followers 205 further function to carry the centrifugal load of the spinning disk 40 as well as to maintain the seal gap located between the rotating inlet and outlet ends 106, 108 of the coolant passage 103 and the fixed passagways 206, 208, as described in more detail below.

The cam housing 300 has a generally rectangular shape with opposed parallel sidewalls 304, the cam bearing surface 302, and an internal cavity 306. Preferably one of the sidewalls 304 is formed from a removable plate 310 for accessing the interior portion of the cavity. Sidewalls 304 preferably have truncated interior corners 305 so that the semi-hemispherical frame 200 can rotate without interference.

Contained within the internal cavity 306 are return and feed coolant lines 206, 208 which are connected to and along the curved underside of the cam bearing surface 302. The feed and return coolant lines 206, 208 further comprise slots 210 aligned with passageways 310 of the curved bearing surface 302. The slots 210 of the feed and return coolant lines 206, 208 are in fluid communication with the respective ends 106, 108 of the coolant passage 103. It is important to note that the ends 106, 108 of the coolant passage 103 rotate or tilt with the semi-hemispherical frame 200 and maintain fluid communication with the non-rotating return and feed coolant lines 206, 208 during rotation. In addition, as the semi-hemispherical frame 200 rotates, the outer wear surface 202 of the frame functions as a seal to prevent coolant from escaping from passageways 310 of the curved bearing surface 302. Preferably, one or more grooves 314 surround the periphery of the passageways 310 of the cam bearing surface 302 wherein one or more seals 320, preferably o-ring, are provided therein to prevent coolant from escaping from the internal cavity. An optional second set of grooves and seals may be used as a “telltale” i.e., to indicate coolant leakage from the cam housing.

The wafer pedestal assembly further comprises a flange 400 for connecting to an actuator. The actuator may be comprised of linkages, cables, electric actuators or any means to convey the motion to the movable portion of the wafer pad.

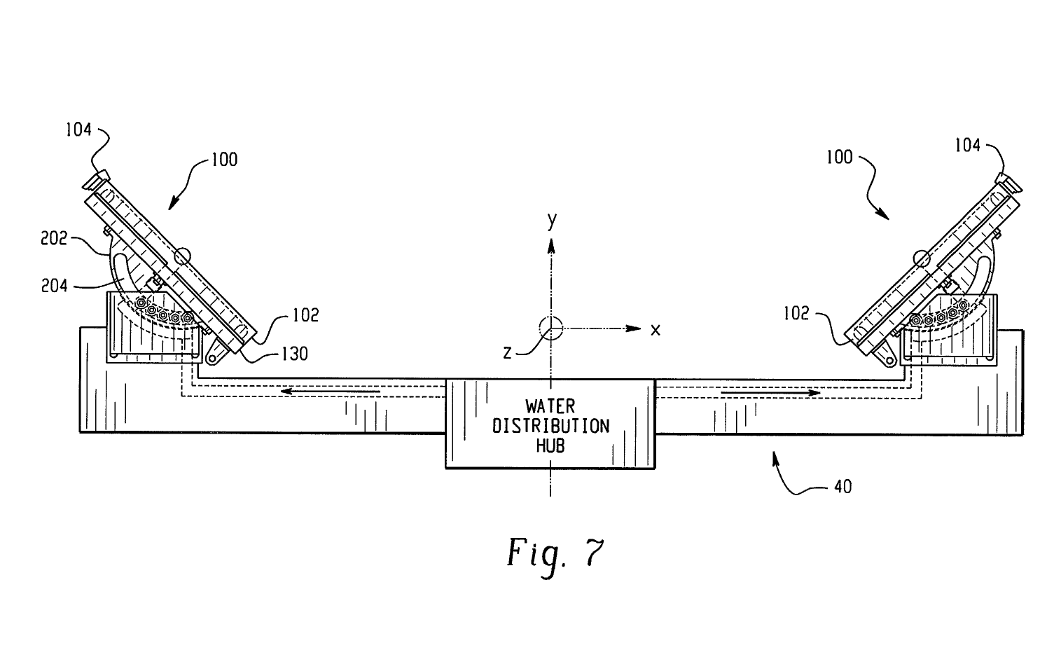

FIG. 7 illustrates the side perspective view of an ion implanter disk having two or more wafer pedestals of the invention mounted thereon. The wafer pedestal assemblies 100 are shown tilted at a 45 degree orientation. A coolant distribution hub 500 is shown located near the center portion of the disk 40 with coolant manifold system lines extending radially outward in fluid communication with the return and feed lines 206, 208 of the pedestal assembly.

While the wafer cooling system has been shown and described in conjunction with an assembly for tilting wafers, the above referenced cooling system is not limited to such application. For example, the wafer cooling system could also be used in conventional batch or serial ion implanters. Further, while the wafer pedestal tilting mechanism is shown primarily for use in a batch type ion implanter, the invention could also be used in conjunction with serial ion implanters. Finally, the wafer pedestal tilting mechanism could also be used with other cooling systems.

INVENTORS: HOW WOULD YOU MODIFY THE INVENTION FOR USE IN A SERIAL IMPLANTER? See drawing sent by Weed

While the invention has been shown and described with respect to specific embodiments thereof, this is for the purpose of illustration rather than limitation, and other variations and modifications of the specific embodiments herein shown and described will be apparent to those skilled in the art within the intended spirit and scope of the invention as set forth in the appended claims.

We claim:

1. A wafer pad assembly for mounting and cooling a wafer and being disposed in an ion implanter, the wafer pad assembly comprising:
a wafer support pad having an upper surface for mounting said wafer and a lower surface, said lower surface of said wafer support pad being connected to a coolant passage having an inlet section and an outlet section arranged in an opposed configuration, wherein said inlet section is counterbalanced by said outlet section.

2. The wafer pad assembly of claim 1 wherein an inlet end of said inlet section and an outlet end of said outlet are located proximate to the center of said wafer.

3. The wafer pad assembly of claim 1 wherein said coolant passageway is arranged in a serpentine configuration.

4. The wafer pad assembly of claim 1 wherein said inlet section and said outlet section are arranged in a symmetrical configuration.

5. The wafer pad assembly of claim 1 wherein said lower surface of said wafer support pad is connected to a frame having an outer curved surface in mating engagement with a complementary shaped bearing surface of a housing wherein said wafer can be rotated about an axis.

6. The wafer pad assembly of claim 5 wherein said bearing surface further comprises a feed passageway and a return passageway in fluid communication with a feed line and a return line, respectively.

7. The wafer pad assembly of claim 6 wherein said feed line and said return line are in fluid communication with the inlet and the outlet of the cooling passage, respectively.

8. The wafer pad assembly of claim 5 wherein said frame further comprises a curved raceway secured to the housing via one or more cam followers.

9. The wafer pad assembly of claim 6 wherein the outer curved surface of the frame functions to seal the feed and return passageways of the bearing surface.

10. A wafer pad assembly for mounting a wafer and being disposed in an ion implanter, the wafer pad assembly comprising:
a wafer support pad having an upper surface for mounting said wafer and a lower surface, said lower surface being connected to a frame having an outer curved surface in mating engagement with a complementary shaped bearing surface of a housing wherein said wafer can be rotated about an axis.

11. The wafer pad assembly of claim 10 wherein said outer curved surface is convex.

12. The wafer pad assembly of claim 10 wherein said frame further comprises a curved raceway secured to the housing via one or more cam followers.

13. The wafer pad assembly of claim 10 wherein said wafer is tiltable about the X axis in the range of about 0 to about 45 degrees.

14. The wafer pad assembly of claim 10 wherein said frame further comprises opposed raceways secured to the housing via a plurality of cam followers.

15. The wafer pad assembly of claim 10 further comprising a cooling passage connected to the lower surface of said wafer support pad; said cooling passage having an inlet section and an outlet section, wherein said inlet section is counterbalanced by said outlet section.

16. The wafer pad assembly of claim 15 wherein said bearing surface further comprises a return passageway and a feed passageway, wherein said return passageway is in fluid communication with a return line and the outlet of the cooling passage; and said feed passageway is in fluid communication with the feed line and the inlet of the cooling passage.

17. The wafer pad assembly of claim 15 wherein said bearing surface seals said return passageway and said feed passageway.
